(19) United States
(12) Patent Application Publication
(10) Pub. No.: US 2011/0093334 A1
(43) Pub. Date: Apr. 21, 2011

(54) METHODS, DEVICES AND SYSTEMS FOR PROVIDING SUPERIOR ADVERTISING EFFICIENCY IN A NETWORK

(75) Inventor: Craig Wood, San Diego, CA (US)

(73) Assignee: RAAVES, INC., San Diego, CA (US)

(21) Appl. No.: 12/761,176

(22) Filed: Apr. 15, 2010

Related U.S. Application Data
(60) Provisional application No. 61/169,506, filed on Apr. 15, 2009.

(51) Int. Cl. G06Q 30/00; G06F 15/173

(52) U.S. Cl. 705/14.53; 709/224

(57) ABSTRACT

Provided herein is a system and device comprising at least one database module that is configured to monitor a referral count or an opinion agreement count of at least one user of a network. Also provided herein is a method for advertising a product or service to at least one user of a network comprising targeting the product or service to the user using transformed data derived from the activity of the user. Also provided herein is a method for a user of a network to access content and information stored in a different user's database module that is locally stored and/or locally controlled.

This application claims the benefit under §119 of U.S. Appl. No. 61/169,506 filed Apr. 15, 2009 entitled “Methods, Devices and Systems for Providing Superior Advertising Efficiency in a Network,” which is hereby incorporated by reference in its entirety.

### BACKGROUND OF THE INVENTION

Many businesses are said to be “referral-based” in the sense that the best advertisement for the business is a happy customer who is eager to tell friends, family members, colleagues, and the like about the positive experiences they had with a particular product or service. Businesses favor these “word of mouth referrals” because they build loyalty in clients and customers and provide relatively inexpensive advertisement for the business.

### SUMMARY OF THE INVENTION

Provided herein are devices, methods and systems for providing increased efficiency in the advertisement of products and services to members of a subject population. Also provided herein are methods, devices and systems for utilizing the influence of a particular member within a population as a vehicle for marketing products and services to other members within the same network, thereby leveraging the social influence of the vehicle to advertise products and services to members within the network.

In one aspect, provided herein are methods, devices and systems for advertising products and services that provide one or more of the following advantages over existing methods, devices and systems: (1) an increase in user convenience or an increase in the number of new ratings or recommendations for a product or service that is provided to a user within a network; (2) user defined customization; (3) a configuration for the identification of an opinion leader or referral leader within a network; (4) opportunities for a highly targeted advertising campaign through the immediate identification of the number of internet-based “word of mouth” referrals; and (5) opportunities for users within a network to obtain and share information about the content stored within a user's database and to optionally access a referral count or an opinion agreement count of a user within a network.

In one aspect, provided herein are devices and systems comprising at least one database module that is configured to monitor a referral count or an opinion agreement count of at least one user of a network.

In another aspect, provided herein is a method for advertising a product or service to at least one user of a network comprising targeting the product or service to the user using transformed data from the activity of the user.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 illustrates a non-limiting schematic rendition of a hierarchical model in the form of a circle depicting the relationships between several members within a network. For example, in this embodiment, the member 1 has a total referral count of 24 as shown with the relationships between the members identified with 2 and the members identified with 3.

FIG. 2 illustrates a non-limiting schematic rendition of a hierarchical model in the form of a tree depicting the relationships between several members within a network. For example, in this embodiment, the member 1 has a total referral count of 8 as shown with the relationships between the members identified with 2 and the members identified with 3. When member 3 joined the network by accepting an invitation from member 2, a value is assigned to member 1 and member 2. In this example, 8 members either directly or indirectly accepted the invitation from member 1, so member 1 has a referral count of 8, whereby two counts are from the level 1 and 6 counts are from level 2.

FIG. 3 illustrates a non-limiting schematic rendition of a flow diagram depicting various steps in the process for growing a network. First, a member joins the network. By way of a non-limiting example, the member in this example joins the network via the internet or via cellular-based network (using a cell phone). If the member has joined via an invitation from another member, the member is added to the hierarchical model of the member who sent the invitation. The member is then assigned the appropriate database module value (e.g. “2” for Member Level or “1” for Network Level) depending on the position of the member within the hierarchical model. The database module also assigns a referral count (also referred to as a referral leader value) to the most senior member in the hierarchical structure, which is referred to in the Example as a “start node.” The referral count for the most senior party is based on the total number of members in the hierarchical structure, excluding that most senior party.

FIG. 4 illustrates a non-limiting schematic rendition depicting one embodiment of the storage and transmission of ratings, recommendations and other information of interest to users within a network on the locally controlled computerized entity of the respective users depicted in the figure.

FIG. 5 illustrates a non-limiting schematic rendition depicting one embodiment of the methods, devices and systems provided herein to identify one or more potential opinion leaders. First, a database module is created that stores user profile data and product and service categories for each user of a network. For example, in further embodiments, each user has a personal folder for each category such as books, movies, music, and the like. A user interface is built to allow remote members, distributed across vast geographical areas, to network between each other and exchange ratings on products and services via, for example the internet or a public cellular phone connection. People then join the network and select a numerical value (e.g. 1-5) for an item (e.g. a book) and then send the numeric values and specific names of items to other individuals within the network. A user database module then stores all ratings that are sent in each category and identify to whom the ratings are sent and by whom. Recipients of the ratings then save, delete, and/or forward referred items and ratings. All actions (e.g. saving and deleting) are stored in the database module including ratings that are forwarded to others, to whom they are forwarded, and by whom they are forwarded. Members within the network can then display the user ratings network (e.g. most popular items displayed, and the like).

FIG. 6 illustrates a non-limiting schematic rendition depicting one embodiment of the methods, devices and systems provided herein whereby members of a network send ratings, e.g. numeric ratings, on specific products or services to one or member within the network. Each time a member sends a rating, the value of the sending member's “referral count” is increased by a value of 1. Thus, each additional referral made by a member increased the referral count by 1. The referral count for each member is divided by the total number of referrals within the network to determine a percentage for each individual. A database module then ranks all members by their referral percentage. Based on a member's position within the ranking, the database is able to transform the raw data and establish a distribution of ratings for all members in the network.

FIG. 7 illustrates a non-limiting schematic rendition depicting one embodiment of the methods, devices and systems provided herein whereby each time a first member receives a reply from second member within the network that is in agreement or concurrence with the first member, a value is added to the first member's user profile in the database module. In further or additional embodiments depicted in FIG. 7, each time a recipient member forwards a rating or packet of information to a different member (e.g. a third member), the forwarded ratings are registered in the database module. In this embodiment, the number of “forwarded ratings” and “concurred ratings” is monitored and tracked by the database module. A member is designated as an “opinion leader” when the number of forwarded ratings and concurred ratings is above average when compared to other members of the network.

FIG. 8 illustrates a non-limiting schematic rendition depicting one embodiment of the methods, devices and systems provided herein whereby a first member sends a rating to a second member. The second member in turn replies to the first member indicating the second member agrees with the first member. The second member then forwards the rating to a third member and to a fourth member. In the depicted embodiment, a database count transforms the activity of the first member and assigns an increase in opinion agreement rate by 1 for the “concur value” and an increase by 1 for the “forward value”. The database module then transforms the concur value and divides into by the total number of ratings the first member sent to the second member. The database module also transforms the forward value for the first member and divides it by the total number of ratings the first member has sent the second member. In some embodiments, if the total of the concur percentage and the total value of the forward percentage is greater than a percentage set by a network operator, the first member's opinion leader value is set to 1.

FIG. 9A illustrates a non-limiting schematic rendition depicting one embodiment of the methods, devices and systems provided herein illustrating a population of network members where each circle represents a member within the network. For purposes of this example, provided are 60 members of the network, whereby the cost to advertise to these members is 60 units.

FIG. 9B illustrates a non-limiting schematic rendition depicting one embodiment of the methods, devices and systems providing a subset of the members of Example 9A, graphically depicting a sub-set of the population of members that have provided ratings for a specific product or service. For purposes of this example, because there are 23 members that have provided ratings on a specific product or service, the cost to advertise to these targeted members is 23 units.

FIG. 9C illustrates a non-limiting schematic rendition depicting one embodiment of the methods, devices and systems described herein. Provided in this example is a graphical representation of the increased efficiency by directing to advertisers specific opinion leaders and referral leaders within the network. In this example, because the network database module identifies the opinion and referral leaders, the advertiser is provided a reduction in total cost from 23 units of FIG. 9B to 3 units of FIG. 9C. The savings to the advertiser is a reduction of 95% compared to advertising to the general population (e.g. depiction in FIG. 9A) and a cost efficiency of 87% compared to advertising to a sub-set of the population (e.g. depiction in FIG. 9B).

FIG. 10 illustrates a non-limiting schematic rendition depicting one embodiment of the methods, devices and systems described herein. Provided in this example is a graphical representation of a user of the network using a viewer to view the storage folders of other users of the network.

### DETAILED DESCRIPTION OF THE INVENTION

Many websites exist that provide the opportunity to provide a recommendation or rating for a product or service. However, at present, there is no equivalent web-based feature for “word of mouth” referrals. Rather, existing websites are centrally located and store data on centrally located servers. Websites accessible through a central location often present difficulties to consumers in determining the accuracy and reliability of reviews posted on the website. These conventional websites also make it difficult for advertisers of a product or service to selectively target specific consumers of a product or service.

Described herein are technologies that addresses the shortcomings of prior methods, devices and systems for advertising to a consumer or client, thereby offering a completely integrated method, device and system by which advertisers of a product or service can more efficiently market their businesses directly to consumers and clients within a network population.

The novel features provided herein are set forth with particularity in the appended claims. A better understanding of the features and advantages of the subject matter provided herein will be obtained by reference to the following detailed description. The instant disclosure can, however, be embodied in many different forms and should not be construed as limited to the embodiments set forth herein; rather, these embodiments are provided so that this disclosure will be thorough and complete, and will fully convey the scope of the invention to those skilled in the art.

As used herein, the words “comprise,” “comprising” and “contain” and variations of them mean “including but not limited to” are not intended to (and do not) exclude other additives, components, steps, integers, values, and the like.

As used herein, the singular encompasses the plural unless the context otherwise requires. In particular, where the indefinite article is used, the specification is to be understood as contemplating plurality as well as singularity, unless the context requires otherwise.

Features, characteristics, groups, and the like described in conjunction with a particular aspect, embodiment or example of the subject matter described herein are to be understood to be applicable to any other aspect, embodiment or example described herein unless incompatible therewith. All of the features and embodiments disclosed in this specification (including any accompanying claims, abstract and drawings), and/or all of the steps of any method or process so disclosed, may be combined in any combination, except combinations where at least some of such features and/or steps are mutually exclusive. The subject matter as described herein is not restricted to the details of any foregoing embodiments.

The methods, devices, and systems described herein provide increased advertising opportunities directed to members of an inter-related and networked group of people by harnessing an individual's social influence and demonstrated history of making referrals and recommendations within the group. Also provided herein are methods, devices and systems for capturing the business leads from referral leaders within a networked group of people and quantifying the influence of a referral leader or an opinion leader within the group, thereby providing a more efficient and streamlined opportunity for targeted advertisement of products and services within the users of a network.

As used herein, a “referral leader” refers to a user (also referred to herein as a member) within a networked group of people who has demonstrated an ability to make referrals or recommendations to a high number of users (e.g. other people) within the network. For example, in some embodiments, a referral leader's ability to perform a high number of referrals or endorsements is based on the user's position within the network and relationships with other users. In further or additional embodiments, a database module provided herein is configured to monitor the referrals of a user and transform the assessment of the user's referrals into a value referred to as a referral count.

In some embodiments, the “referral count” is a value correlated to the number of times a user refers a product or service to another user within the network. In some embodiments, the referral count for a referral leader is greater when compared to the referral count for an average user within the network. For example, in one embodiment, a referral leader has twice the referral count relative to the average user within the network. In another embodiment, the referral leader has three times the referral count relative to the average user within the network. In a further embodiment, a referral leader has four times the referral count compared to the average user within the network. In still further embodiments, the referral leader has greater than four times the referral count compared to the average user within the network.

As used herein, an “opinion leader” refers to a user within a network who has demonstrated an ability to initiate opinions, ratings, recommendations and other information of interest of which other users within the network agree at an above average rate. For example, in some embodiments, the willingness of others within the network to agree with an opinion leader's rating is based on the opinion leader's position within the network and relationships with other users. In further or additional embodiments, the database module is configured to monitor the ratings and recommendations of a user and transform the ratings and recommendations into a value referred to as the opinion agreement count.

In some embodiments, the “opinion agreement count” as used herein is a value for a user that is correlated to the number of times a different user forwards, concurs, or replies in agreement with the user's referral (e.g. a rating). In some embodiments, the opinion agreement count for an opinion leader is greater when compared to the opinion agreement count of an average user within the network. For example, in one embodiment, an opinion leader has twice the opinion agreement count relative to the average user within the network. In another embodiment, the opinion leader has three times the opinion agreement count relative to the average user within the network. In a further embodiment, an opinion leader has four times the opinion agreement count compared to the average user within the network. In still further embodiments, the opinion leader has greater than four times the opinion agreement count compared to the average user within the network.

### Monitoring the Growth of the Network

A feature of some embodiments of the subject matter provided herein is the monitoring of a network's growth in terms of the number of users or members within the network. Provided herein are methods, systems and devices for monitoring the growth of a network.

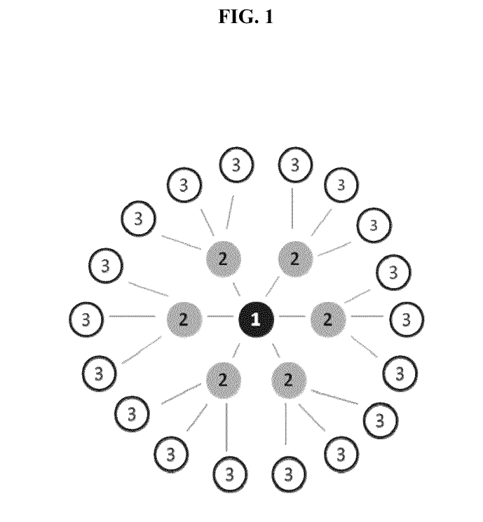

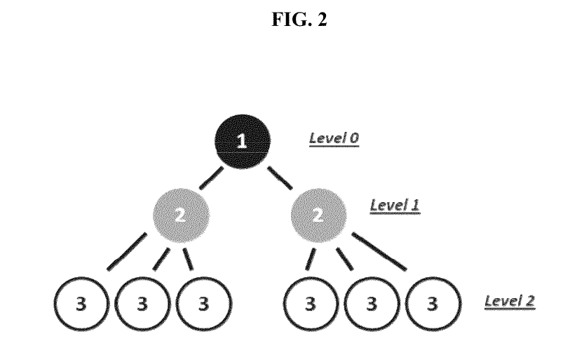

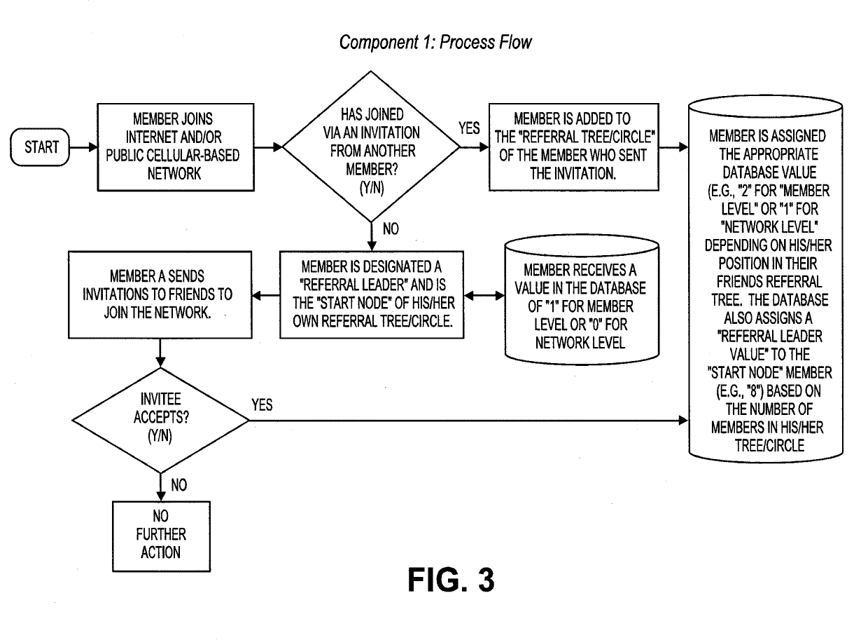

The term “user” as provided herein is interchangeable with the term “member” and refers to a person or entity within the network. In some embodiments, provided herein is a database module that is configured to transform information pertaining to at least two users of a network into a hierarchical model depicting the relationship between the users. The term “hierarchical model” refers to a representation of data about one or more user organized into a tree-like structure or organized into a circle that depicts the relationships between two or more users within the network. In some embodiments the hierarchical model is the form of a circle as depicted, for example, in FIG. 1. In some embodiments, the hierarchical model is the form of a circle, as depicted for example in FIG. 2.

In some embodiments, provided herein is a method, system and device for monitoring the growth of a network. In further or additional embodiments, the growth of a network is monitored by tracking growth. In some embodiments, the tracking of growth begins by identifying a “referral leader.”

For example, in numerous embodiments provided herein, a user within the network invites a potential user to join the network. In further or additional embodiments, a user within the network will invite another user within the network thereby bringing to the attention of the user a product. In other embodiments, a user within the network invites another user within the network bringing to the attention of the user a service. In further or additional embodiments as discussed herein, a user within the network recommends or suggests that the user purchase a product or service.

In some embodiments, when a person joins the network, thereby becoming a “user” or “member,” a database module tracks the initial point the user joins the network. In some embodiments, when a new user joins the network, a database module performs a “cross check” to determine whether the new user has ever received an invitation to join the network in the past. In further embodiments, when a new user joins the network, a database module will determine whether the new user has ever received an invitation from a specific user to join the network in the past.

In some embodiments of the systems, methods and devices described herein, the potential new member has previously received an invitation to join the network. In these situations, once the potential new member joins the network, the new member will be considered a “net, new member” and a value is assigned in the database module for the new member (e.g. “1” for Member and “0” for Network Level). If a new member joins the network as a result of accepting an invitation from another member, the new member will be added to the hierarchical model of the member who sent the accepted invitation to the new member.

In some embodiments of the subject matter provided herein, invitations sent from all users are tracked. For example, in some embodiments, members that previously accepted an invitation from a member in turn send an invitation to one or more potential new members. In situations where a potential new member accepts the invitation, the potential new member is transformed into a new member. In certain embodiments, this protocol for acceptance of new members within the network is repeated. For example, when a new member joins the network by accepting an invitation from a member who previously accepted an invitation from another member, values are assigned by the database module, whereby the most senior member of each hierarchical model has the highest referral count. See, for example, FIG. 2.

### Differentiated Network Architecture

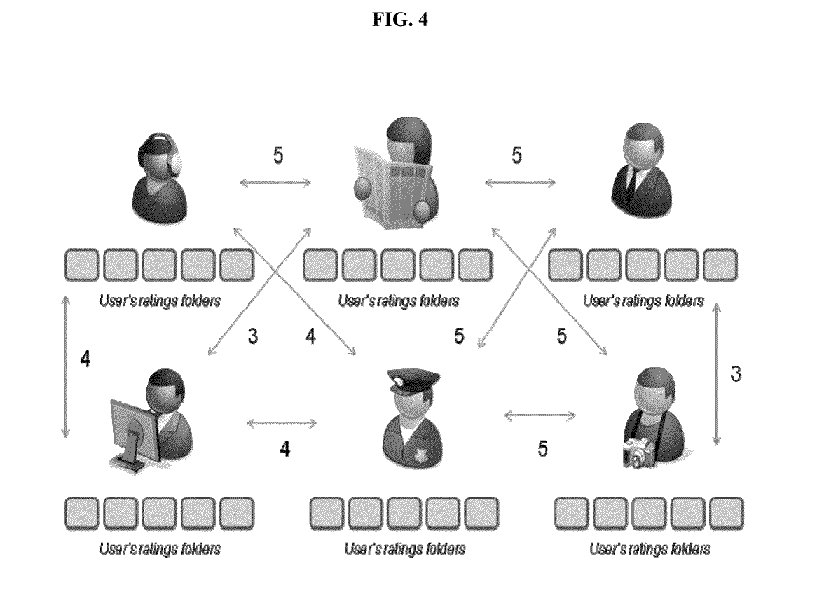

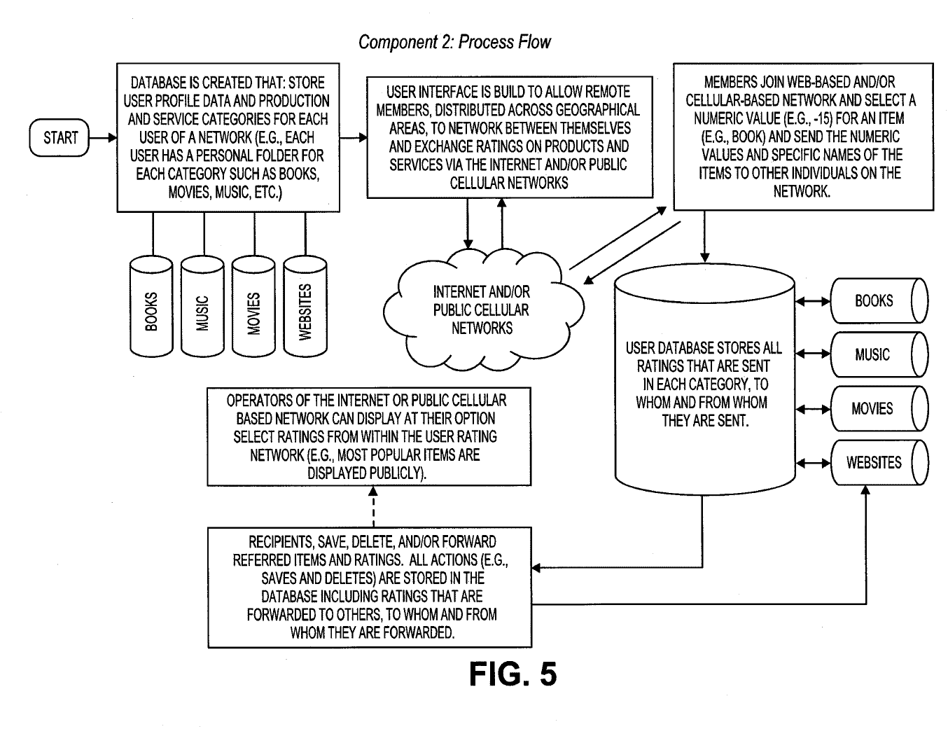

A feature of some embodiments of the subject matter provided herein is a differentiated network architecture that comprises the exchange and storage of ratings and other information on personal items of interest between the users within a network, directly and without the need to access a centralized publicly available website. For example, in some embodiments, the “file-shared” information includes rating and information on books, movies, restaurants, professional services, wine, music, and the like. Several embodiments of the methods, devices and systems provided herein are illustrated in FIGS. 4 and 5.

Provided herein are methods, systems and devices for providing the exchange of items of interest, including, but not limited to information, ratings, recommendations and the like, from the local storage of one user of the network to the local storage of another user of the network. As used herein, the phrases “local storage” and “locally” refers to the storage of information that is within the user's computerized device of the user of the network. In some embodiments, rather than a user of the network needing to access a publicly available website to obtain information of interest, the information of interest, e.g. ratings or recommendations, is accessible through the “locally” stored information in a folder of a computerized device of the transmitting user. In other embodiments, an accessing user views information of interest stored in a different user's computerized entity.

In some embodiments, the ratings, recommendations, and other information of interest of a user within a network is transmitted to a different user within the network. In further or additional embodiments, the ratings, recommendations, or other information of interest that is transmitted from one user to another user is transmitted from a local storage medium within the transmitting user's computerized device. In further or additional embodiments, after transmission of the ratings, recommendation or information of interest is complete, the transmitted information is stored locally in the recipient user's computerized entity.

In further or additional embodiments, the ratings, recommendations, or other information of interest that is transmitted from one user to another user is transmitted and stored locally in the recipient user's computerized device and is accessible by the recipient user. In some embodiments, the recipient user requested the information. In other embodiments, the recipient user did not request the information. In embodiments where the transmitting user did not request the information, the transmitting user, e.g. a referral leader or opinion leader, unilaterally transmitted the information to the computerized device of the recipient user.

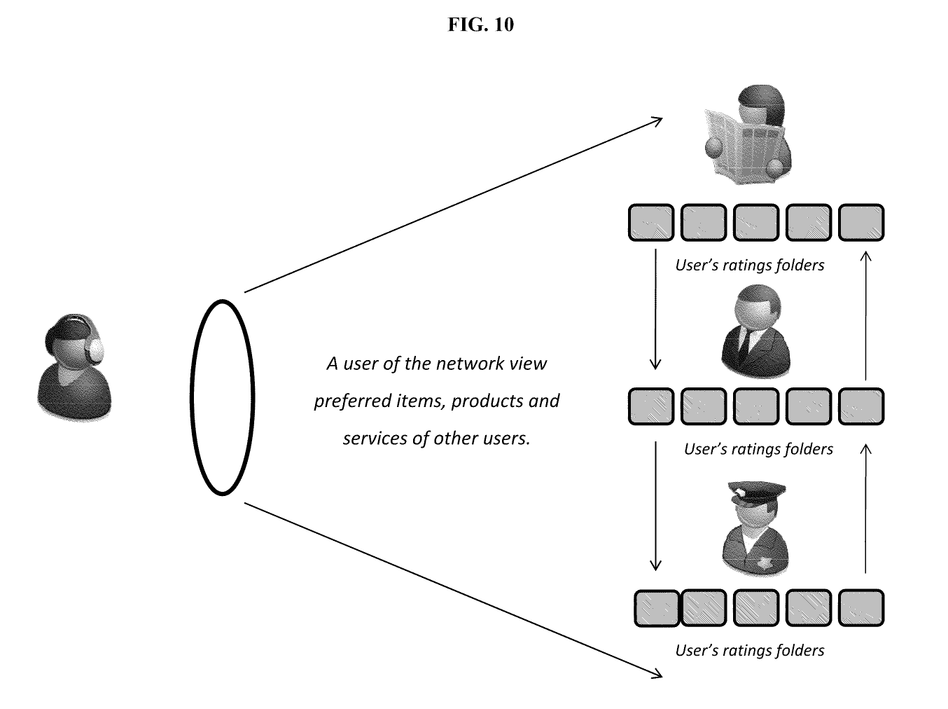

In further or additional embodiments, provided herein are devices, methods and systems comprising a viewer that is configured to view one or more storage folder of the same or different user. For example, in some embodiments, the viewer feature is used by at least one user to view the ratings, recommendations, or other information of interest that is stored on a user's computerized entity, e.g. in a storage file. See, e.g., FIG. 10. In further embodiments, the viewer feature is used by a user of the network to view ratings, recommendations, or other information of interest that is stored locally on a user's computerized entity. In still further embodiments, the viewer feature of the instant disclosure provides the added benefit of facilitating the viewing of ratings and recommendations and other information of interest without the use of accessing a centrally located database. For example, in some embodiments, the viewer is used to obtain information of interest and the information of interest is related to a movie, a television show, a game show, a popular product or service, an employment opportunity, and the like. In still further embodiments, the viewer feature is incorporated into a method, device or system.

In some embodiments, the users of the network access the information of interest, including, but not limited to, ratings or recommendations from another user's local storage. For example, in some embodiments, the information of interest is related to a movie, a television show, a game show, a popular product or service, an employment opportunity, and the like.

In some embodiments, the transmission of information to and from users within a network occurs over the internet. In some embodiments, the transmission of information to and from users in a network occurs over a cellular telephone connection. In further or additional embodiments, the transmission of information to and from users within a network occurs over a standard wireless protocol used to efficiently transfer data.

In some embodiments, the viewing of information from a user's computerized device occurs over the internet. In some embodiments, the viewing of information from a user's computerized device occurs over a cellular telephone connection. In further or additional embodiments, the viewing of information from a user's computerized device occurs over a standard wireless protocol used to efficiently transfer data.

Computerized Devices of a User in a Network

In some embodiments of the methods, devices and systems described herein, the computerized entity is a personal computer, e.g. a laptop computer or traditional computer with monitor separate from the hard drive, or a combination thereof. In further embodiments, the computerized entity provided herein is configured to display the information of interest of the user of the computerized entity on, e.g., a monitor or user interface.

In further embodiments, provided herein is a computerized entity that is a personal computer. In further embodiments, the personal computer is configured with software and hardware that enables the user to access their own information of interest. In further or additional embodiments, the computerized entity is configured with software and hardware that enables a different user within the network to access information of interest stored on the user's computer.

In further or additional embodiments, the computerized entity is a hand-held computer. In further embodiments, the computerized entity is a personal computer containing a tablet. In some embodiments, the medical device is a tablet personal computer. In further embodiments, the tablet is a notebook or a slate shaped mobile computer equipped with a touchscreen or graphics tablet/screen hybrid, whereby the healthcare professional enters medical data of a patient with a stylus, digital pen, fingertip, or combination thereof.

By way of non-limiting examples, exemplary computerized entities include the PaceBlade SlimBook 200®, the Fujitsu Stylistic ST5010®, the Electrovaya Scribbler SC4000®, Panasonic Toughbook 08®, TabletKiosk Sahara i400®, Samsung Q1®, Xplore Technologies®, Acer TravelMate C100/C300/C310, Dialogue Flybook V5®, Fujitsu LifeBook P1610/P1620®, HP Compaq EliteBook 2730p®, HP Pavilion tx2500z®, Toshiba Satellite R10/R15/R20/R25®, and Compaq TC 1000®.

In further or additional embodiments, the computerized device is any device that contains the necessary hardware and/or software to access information contained in storage media. For example, in some embodiments, the computerized device contains a display interface (e.g. a monitor) operably linked to a storage medium. In some embodiments, the computerized device comprises a display interface operably linked to a CD storage medium. In other embodiments, the computerized device comprises a display interface that is operably linked to a DVD storage medium. In further embodiments, the computerized device comprises a display interface that is operably linked to a HD-DVD storage medium.

In some embodiments, the computerized entity further comprises a digital camera. In further or additional embodiments, the computerized device is operably linked to a digital audio player. In some embodiments, the computerized device is operably linked to a portable media player. In other embodiments, the computerized device is a operably linked to a card reader.

In further or additional embodiments, the computerized device is any device that contains the necessary hardware and/or software to access storage media. For example, in some embodiments, the computerized device is operably linked to a CD storage medium. In other embodiments, the computerized device is operably linked to a DVD storage medium. In further embodiments, the computerized device is operably linked to a HD-DVD storage medium.

In some embodiments, the computerized entity is a cellular phone or personal digital assistant (pda).

Advantages of the Local Storage and/or Control of Information of a User in a Network

The differentiated network architecture of the methods, devices and systems provided herein comprising the storage of ratings and recommendations locally by a member of a network provides several advantages over a systems that are publicly available (e.g. open to non-members), systems with a central storage of information alike, and other existing systems.

First, the local storage of information of interest provides an increase in user convenience and an increase in the number of new ratings or recommendations for a product or service that is “pushed to” a user within the network. For example, in some embodiments, a user within a network receives new ratings or recommendations from a member within the network on the recipient user's personal cell phone, email, personal computer, or a website as soon as they log in without any request by the recipient user.

Second, the methods, systems and devices described herein provide user defined customization. For example, in some embodiments, a user of a network chooses to allow or block other users within the network, certain types of products or certain types of services suggested by other members within the network. In certain embodiments, the methods, devices and systems described herein are configured for a user to pre-determine which types of information about products and services they are willing to receive and optionally from whom they are received.

Third, the methods, devices and systems provide a configuration for the identification of an opinion leader by a network operator, including but not limited to, members of the network, for advertisers to use as targets to advertise products and services to the opinion leader directly, and indirectly to the other members of the network, or directly to any member of the network.

Fourth, the methods, systems and devices described herein provide a highly targeted advertising campaign through the immediate identification of the number of online “word of mouth” referrals. For example, in some embodiments, the methods, devices and systems described herein transform raw information about one or more user within the network into a data that a company can use to identify a consumer of a particular product or service. In some embodiments, an advertiser will use a referral count, an opinion agreement count, an opinion percentile, a referral percentile, a rating value, or a user profile to more efficiently advertise products or services to one or members of the network, either directly to the member, or indirectly through an opinion leader or referral leader.

### Database Module Configured for Monitoring the Activity of Users

Another aspect of the methods, devices and systems provided herein in some embodiments is a database module that is configured to monitor a referral count or an opinion agreement count of at least one user of a network. In some embodiments, a database module is configured to transform the activity of a user in a network into a referral count or an opinion agreement count.

In further or additional embodiments, the database module is further configured to monitor a referral count or opinion agreement count of at least two users of the network. In some embodiments, a database module is configured to transform the activity of at least two users in a network into a referral count or an opinion agreement count for each user.

Determining the Referral Percentile of a User

As described herein, a “referral leader” refers to a user (also referred to herein as a member) within a networked group of people who has demonstrated an ability to make referrals or recommendations to a high number of users (e.g. other people) within the network. A “referral count,” is a value correlated to the number of times a user refers a product or service to another user within the network.

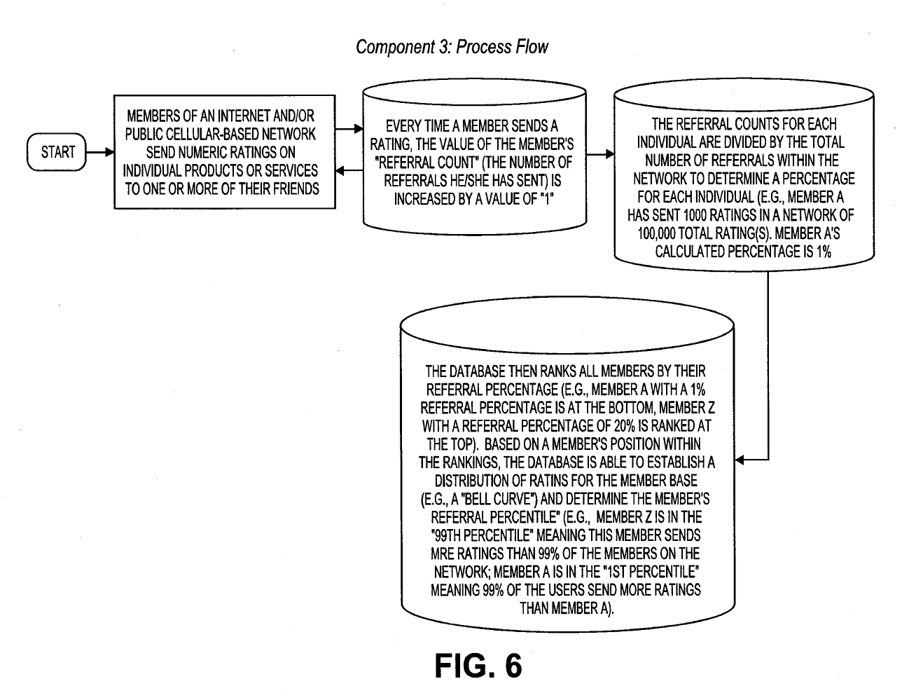

Another feature of some embodiments of the methods, devices, and systems provided herein is a database module that is configured to transform a referral count of a user within the network into a referral percentile for that user. Users with relatively high referral counts corresponding to relatively high referral percentiles in relation to other members of the network are said to be referral leaders. As used herein, a user's “referral percentile” refers to the relative ranking of a user as compared to all other users within the network. See, e.g., FIG. 6.

In some embodiments, the referral percentile of a user is determined using the number of referrals of a specific user relative to all members of the network. For example, suppose user A makes 500 referrals in 10 days. In this example, User A is said to have a “referral count” of 500. Also, suppose all of the others members within the network refer 500 combined referrals 10 days. Therefore, in this example, the referral percentile of user A with respect to the entire network is 50%.

In further or additional embodiments, a pre-set level establishes whether a user is a referral leader. The examples provided herein are for demonstrative purposes only.

In some embodiments, once the referral percentile is determined for each user, the number is then utilized as an input of an engine coupled with the database module to determine the value of the user as a conduit for advertising a product and/or service.

Determining the Opinion Percentile of a User

As described herein, an “opinion leader” refers to a user within a network who has demonstrated an ability to initiate opinions, ratings, recommendations and other information of interest of which other users within the network agree at an above average rate. The “opinion agreement count,” in some embodiments is a value for a user that is correlated to the number of times a different user forwards, concurs, or replies in agreement with the user's referral (e.g. rating).

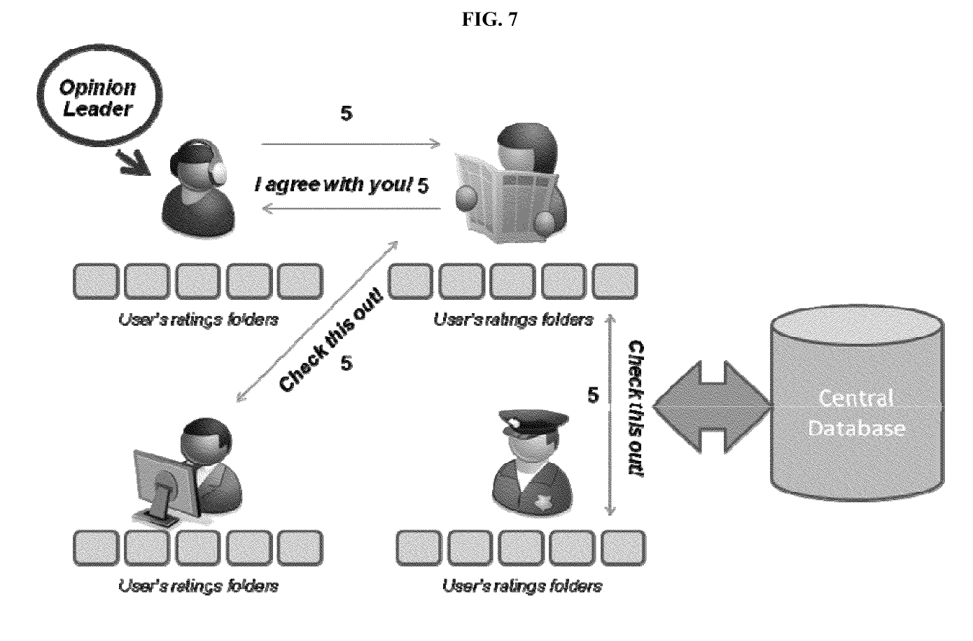

In some embodiments, using the differentiated network architecture, provided herein is a database module that monitors, e.g. through tracking, several aspects of a user's activities within a network. For example, in one embodiment, the database module tracks when a rating has been send from one member to another member within the network. In further or additional embodiments, the database module when a recipient member replies back to the transmitting member. In still further embodiments, the database module tracks when a recipient member forwards a rating to another member within the network. See FIG. 7.

Another feature of some embodiments of the methods, devices, and systems provided herein is a database module that is configured to transform an opinion count of a user within the network into an opinion percentile for that user. Users with relatively high opinion counts corresponding to relatively high opinion percentiles in relation to other members of the network are said to be opinion leaders.

As used herein, a user's “opinion percentile” refers to the relative ranking of a user as compared to other users within the network. In some embodiments, an “opinion percentile” of a user is determined using the number of referrals for a user that a different user forwards, concurs, or replies in agreement with the user's referral (e.g. rating) for a specific user relative to all members of the network.

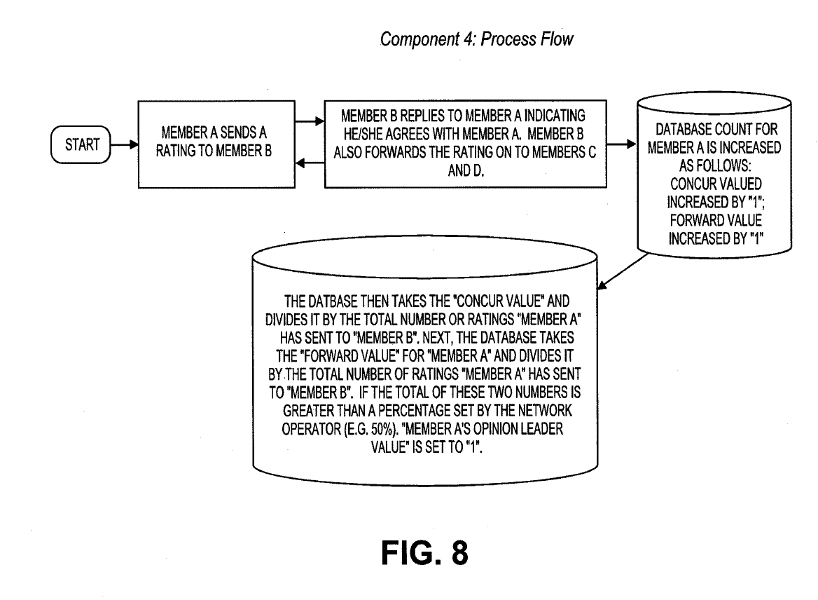

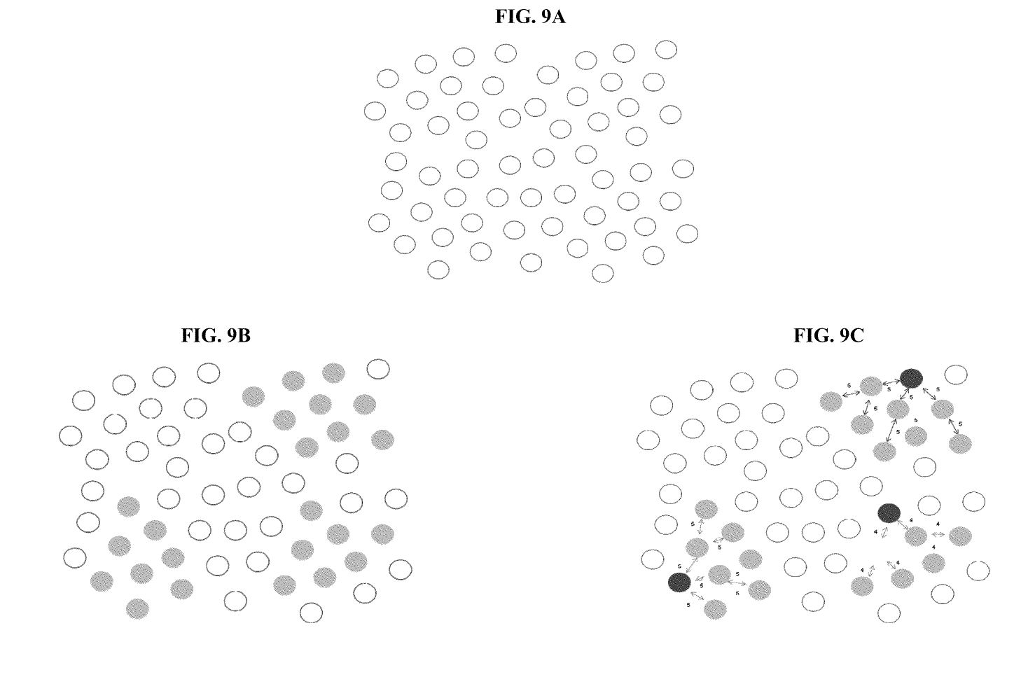

In some embodiments, a network user is an opinion leader with respect to one or more different users within a network. For example, suppose user C sends 100 total referrals to user D. Further, suppose user D replies or concurs with user C on 36 ratings. Also, suppose user C forwards the referral to other users for 20 ratings. The opinion percentile of User C with respect to user D is 56%, determined by (36+20)/100. Assuming that 56% is above average when compared to all other concurrences and responses by user D from other users, with respect to User D, user C is an “opinion leader.” See, e.g., FIG. 8.

In some embodiments, a network user is an opinion leader with respect to all other users in a network. For example, suppose user E sends 1000 total referrals to various other users within the network. Further, suppose the other users within the network reply or concur with user E on 500 ratings. Also, suppose all the other users within the network forward the referral to other users on 50 instances. The opinion percentile of User E with respect to the entire network is 55%, determined by (500+50)/1000. Assuming that 55% is above average when compared to all users within the network, user E is an “opinion leader” with respect to the entire network.

In some embodiments, a user is assigned a numeric value for each instance where the user is an opinion leader. For example, in the example referred to above, user C will have an opinion leader count of at least 1 based user C's opinion leader status in relation to user D.

In further or additional embodiments, a higher or lower threshold establishes an opinion leader. The examples provided herein are for demonstrative purposes only.

In some embodiments, once the opinion percentile is determined for each user, the number is then utilized as an input of an engine coupled with a database module to determine the value of the user as a conduit for advertising a product and/or service.

Using Opinion and Referral Data to Efficiently Advertise Products and Services

Another feature of the methods, devices and systems provided herein is the use of an engine coupled with a database module.

In some embodiments, a database module transforms the activity of a user in a network and further provides a representative referral count or opinion agreement count for the user. In further embodiments, a database module further transforms the respective referral leader count or opinion agreement count into percentiles. For example, in some embodiments, a database module transforms the activity of a user within the network into a referral percentile. In further or additional embodiments, a database module transforms an opinion agreement count into an opinion percentile with respect to a different user within the network. In other embodiments, a database module transforms the activity of a user into an opinion percentile for a user within a network with respect to all users within the network.

In some embodiments, provided herein is an engine coupled to a database module whereby the engine receives one or more input from a database module. In some embodiments, the input is a value transformed from the activity of a user of the network. In further or additional embodiments, the input to the engine is one or more of a referral count, an opinion agreement count, a referral percentile, or an opinion percentile, or a combination thereof.

In further or additional embodiments, an engine or database module, or combination of engine and database module, uses transformed values from activity of users within a network to determine a referral leader or opinion leader within the entire network or in relation to one or more other user.

In still further embodiments, the data is used as an input into an engine, thereby providing direct and indirect targets for advertisers to direct resources to promote a particular product or service.

In further or additional embodiments, provided herein is a method for advertising a product or service to at least one user of a network comprising targeting the product or service to the user using transformed data from the activity of the user. In further or additional embodiments, provided herein is a method where the transformed data is a referral count for the user. In further or additional embodiments, provided is a method where the transformed data is an opinion agreement count for the user. In some embodiments, the transformed data is a referral percentile for the user within the network. In other embodiments, the transformed data is an opinion percentile for the user with respect to a different user in the network. In still further embodiments, the transformed data is an opinion percentile for the user with respect to all other users in the network.

In some embodiments, the coupling of the engine to the database module is by way of a wireless connection. In other embodiments, the coupling of the engine to the database module is by way of a wired connection. In still further embodiments, the database module further comprises the engine.

Sharing and/or Accessing Data Between Users of a Network

Another feature of the methods, devices and systems provided herein is a differentiated network architecture that comprises the sharing of content and information between the users within a network directly and without the need to access a centralized publicly available website. In an embodiment, provided is a method, device, and/or system for a user of a network to access content and information stored in a different user's database module that is locally stored or locally controlled. In these and other embodiments, the user accessing the stored content can “read” the content and information of a different user using its own computing device.

In one embodiment, provided herein is a differentiated network architecture whereby a user within a network accesses or obtains permission to view a referral count or an opinion agreement count of a different user of the network. Thus, in certain embodiments, the referral count and/or opinion agreement count of a particular user of the network will determine the likelihood of the accessed user to having subject matter in the form of content and information stored for that user that is appealing to the accessing user. In further or additional embodiments, the user accesses the content and information of a referral leader and/or an opinion leader. In still further embodiments, a user within a network has the option of blocking other users from accessing its stored content and information, and/or whether it is a referral and/or opinion leader.

In one embodiment, provided herein is a differentiated network architecture whereby a user within a network accesses a referral count or an opinion agreement count of a different user of the network. In further or additional embodiments, provided is a method for a user of a network to access content and information stored in a different user's database module that is locally stored and/or locally controlled. In these and other situations, the user accessing the stored content can “read” the content and information of a different user using its own computing device. And, in still further embodiments, a user accesses the content and information of a different user's database and can visually see the data saved and referrals and/or opinions of that user.

Another feature of the subject matter provided herein is a method of providing to a user of a network a referral count or an opinion agreement count of at least one different user of a network. Thus, in some embodiments, a user determines the likelihood of obtaining information and content that is interesting or desirable to that user based on the referral count or opinion agreement count of a different user within the network. For example, if a particular user A has a referral count and/or opinion agreement count of user B that is desirable or interesting, the user A accesses the user B's data and information. In some embodiments, a user of a network monitors a referral count or an opinion agreement count of a different user of the network.

In further or additional embodiments, the user accesses and reads the content and information of a referral leader and/or an opinion leader. In still further embodiments, a user within a network has the option of blocking other users from accessing its stored content and information, and/or whether it is a referral and/or opinion leader. In yet additional embodiments provided is a method whereby a user in a network shares, and/or a different user accesses, stored content and/or of at least one user of a network of computerized entities on the basis of transformed data derived from the activity of the user of the network. In further or additional embodiments, the transformed data is a referral count for a user. In some embodiments, the transformed data is an opinion agreement count for a user. In yet an additional embodiment, the transformed data is a referral percentile for a user. Still further, in certain situations the transformed data is an opinion percentile for the user with respect to a different user in the network. Further, in some embodiments, the transformed data is an opinion percentile for the user with respect to all other users in the network.

What is claimed is:

1. A system comprising at least one database module that is configured to monitor a referral count or an opinion agreement count of at least one user of a network.

2. The database module of claim 1 that is further configured to monitor a referral count or an opinion agreement count of at least two users of the network.

3. The database module of claim 2 that is further configured to compare the referral count of a first user with the referral count of a second user.

4. The database module of claim 2 that is further configured to compare the opinion agreement count of a first user with the opinion agreement count of a second user.

5. The database module of claim 2 that is further configured to compare the referral count of a first user with the referral count of all users of the network.

6. The database module of claim 2 that is further configured to compare the opinion agreement count of a first user with the opinion agreement count of all users of the network.

7. The database module of claim 4 that is further configured to transform the referral count of the first user into a referral percentile for that user.

8. The database module of claim 1 that is further configured to transform the opinion agreement count of the first user into an opinion percentile for that user with respect to a different user in the network.

9. The database module of claim 1 that is further configured to transform the opinion agreement count of the first user into an opinion percentile for that user with respect to all other users in the network.

10. The database module of claim 1 that is configured to provide the exchange of items of interest from the local storage of one user of the network to the local storage of a different user of the network.

11. The database module of claim 1 that is configured to monitor an opinion agreement count of at least one user.

12. The database module of claim 2 that is configured to monitor growth of the network.

13. The database module of claim 12 that is configured to transform information pertaining to at least two users of the network into a hierarchical model depicting relationship of the users.

14. The network of claim 1 wherein the network is directed to a common interest shared by its users.

15. A method for advertising a product or service to at least one user of a network of computerized entities comprising targeting the product or service to the user on the basis of transformed data derived from the activity of the user on the network.

16. The method of claim 15 wherein the transformed data is a referral count for the user.

17. The method of claim 15 wherein the transformed data is an opinion agreement count for the user.

18. The method of claim 15 wherein the transformed data is a referral percentile for the user.

19. The method of claim 15 wherein the transformed data is an opinion percentile for the user with respect to a different user in the network.

20. The method of claim 15 wherein the transformed data is an opinion percentile for the user with respect to all other users in the network.
